(19) United States
(12) Patent Application Publication
(10) Pub. No.: US 2010/0154583 A1
(43) Pub. Date: Jun. 24, 2010

(54) Collar Having Connecting Device for Attaching Bicycle Accessory

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/343,663

(22) Filed: Dec. 24, 2008

(51) Int. Cl. B62K 21/16

(52) U.S. Cl. 74/551.7

(57) ABSTRACT

A collar for use on a bicycle includes a body for bearing a headset at a higher elevation with respect to a frame tube and safeguarding against a reversion of the headset to a lower elevation. The body includes an annular portion circumferentially attached to a handlebar stem which is attached to the frame tube. Further, a connecting device has a first end thereof including a joint connected to the body and a second end thereof including a quick-release mechanism to which an accessory is releasably attached.

### BACKGROUND OF THE INVENTION

1. Field of the Invention

The present invention relates to collars for use on bicycles and, in particular, to a collar adapted for bearing a headset at a higher elevation with respect to a frame tube to which the headset is adjustably attached, and more particularly, the collar has a connecting device for attaching a bicycle accessory.

2. Description of the Related Art

Generally, a headset in a bicycle includes a handlebar stem adjustably received in a frame tube such that the head set is positionable at various elevations. It is known that the handlebar stem is securely attached to the frame tube by means of a locking collar, and the locking collar can be tightened to securely retain the position of the headset or loosened for making adjustment of the headset. In all likelihood, if the locking collar is not tightened well, there would be a risk that the handlebar stem moves relative to the frame tube. Also, it is considered as a problem that the headset runs out of spaces for accommodating more riders' bicycle accessories.

The present invention is, therefore, intended to obviate or at least alleviate the problems encountered in the prior art.

### SUMMARY OF THE INVENTION

According to the present invention, a collar for use on a bicycle includes a body for bearing a headset at a higher elevation with respect to a frame tube and safeguarding against a reversion of the headset to a lower elevation. The body includes an annular portion circumferentially attached to a handlebar stem which is attached to the frame tube. Further, a connecting device has a first end thereof including a joint connected to the body and a second end thereof including a quick-release mechanism to which an accessory is releasably attached.

In a preferred embodiment, the connecting device is pivotally connected to the body.

In another preferred embodiment, a positioning device is utilized for securely retaining the connecting device at a predetermined pivoting position with respect to the body.

In yet another preferred embodiment, the annular portion has an internal diameter adjustable in size.

### BRIEF DESCRIPTION OF THE DRAWINGS

FIG. 1 is a side view of a collar in accordance with a first embodiment of the present invention, and the collar is installed on a bicycle, and the collar has an accessory attached thereto.

FIG. 2 is a perspective view of the collar and the accessory shown in FIG. 1.

FIG. 3 is an exploded perspective view of the collar and the accessory shown in FIG. 2.

FIG. 4 is a cross-sectional view of the collar and the accessory shown in FIG. 2.

FIG. 5 is another cross-sectional view of the collar and the accessory shown in FIG. 2, but with the accessory pivoted to a different position with respect to the collar.

FIG. 6 is a perspective view similar to FIG. 2, but illustrating a different accessory is attached to the collar.

FIG. 7 is a perspective view of a collar in accordance with a second embodiment of the present invention.

FIG. 8 is an exploded perspective view of a collar in accordance with a third embodiment of the present invention.

FIG. 9 is an exploded perspective view of a collar in accordance with a fourth embodiment of the present invention.

FIG. 10 is a side view of a collar in accordance with a fifth embodiment of the present invention, and the collar is installed on a bicycle, and the collar has an accessory attached thereto.

### DETAILED DESCRIPTION OF THE PREFERRED EMBODIMENT

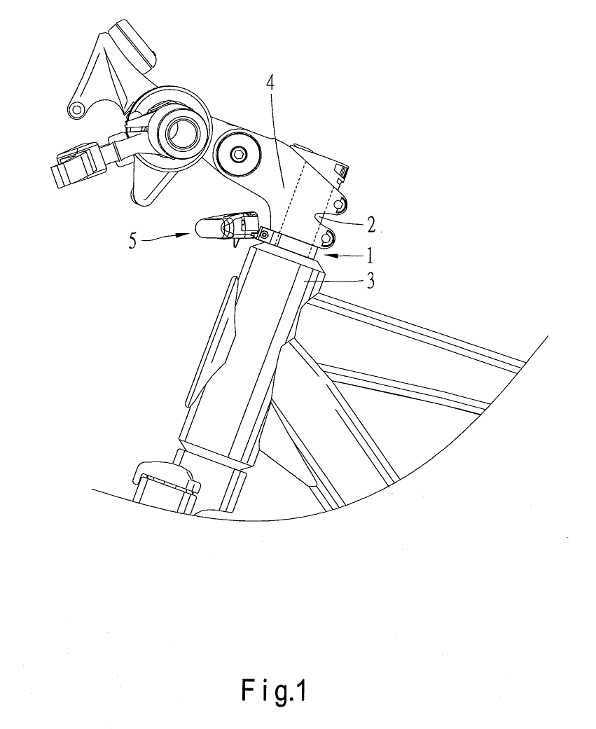

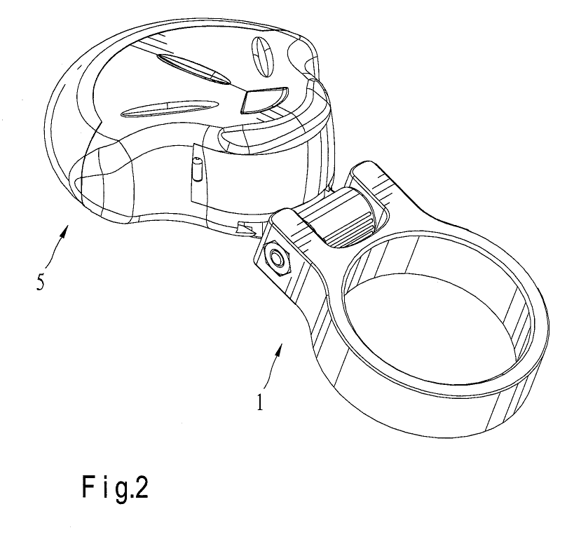

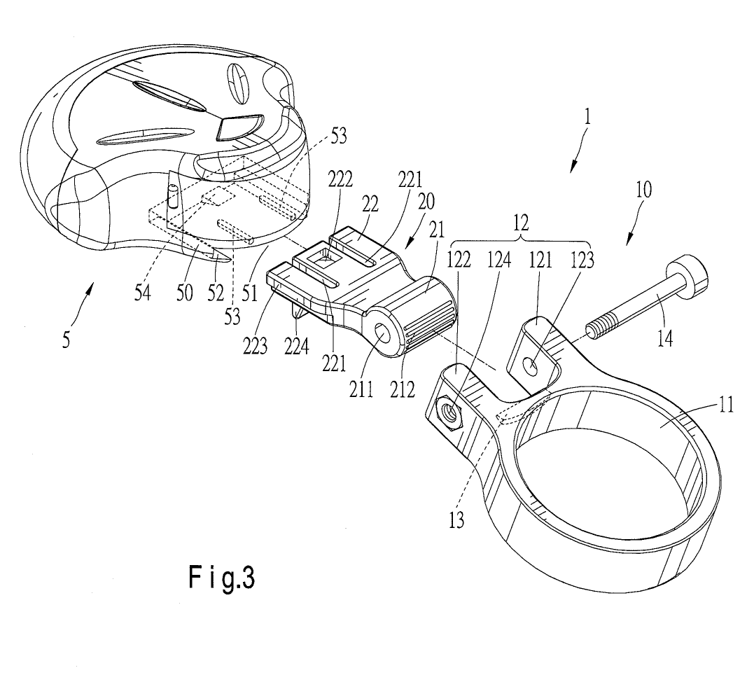

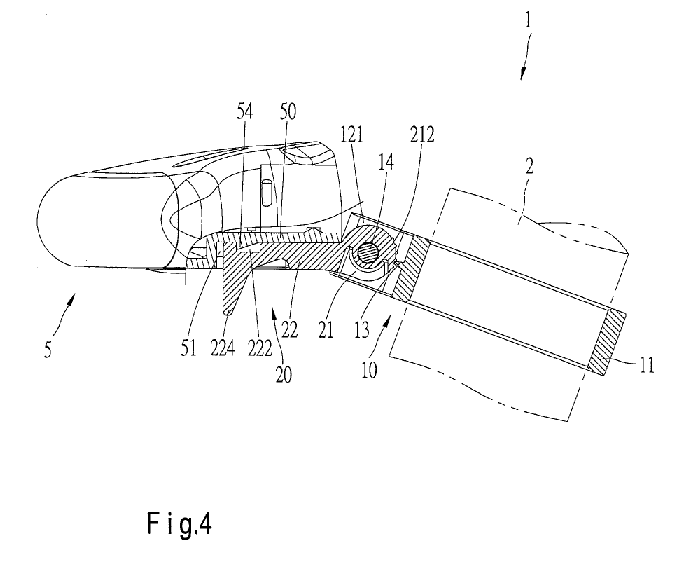

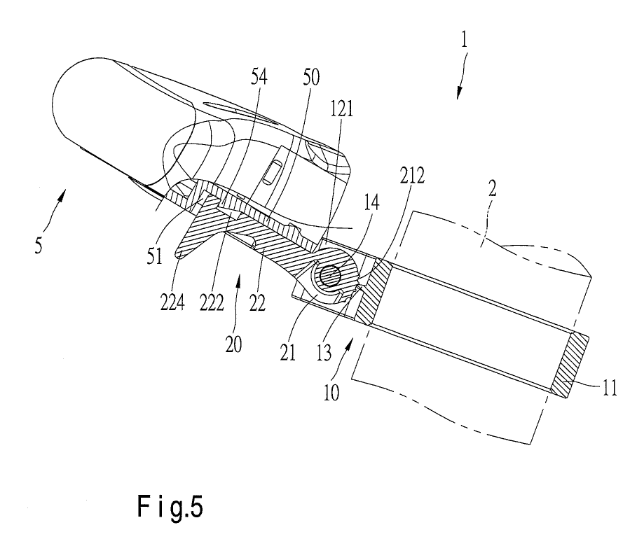

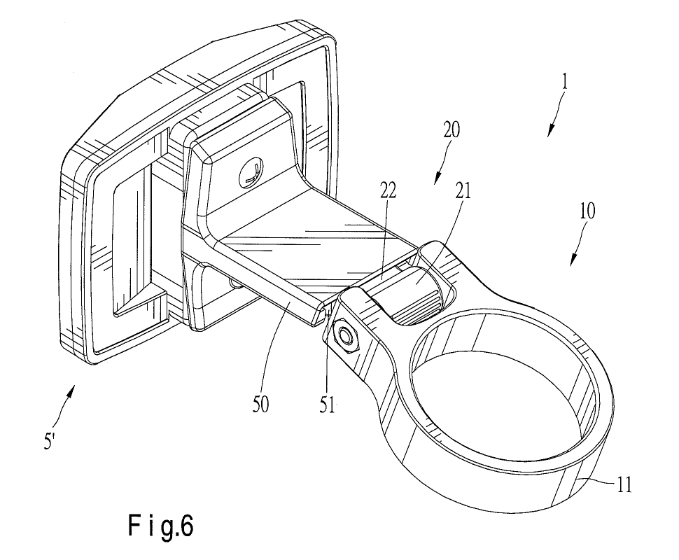

FIGS. 1 through 6 show a collar 1 embodying a first embodiment of the present invention, and the collar 1. The collar 1 is adapted to be installed on a bicycle and includes a body 10 for bearing a headset 4 at a higher elevation with respect to a frame tube 3 and safeguarding against a reversion of the headset 4 to a lower elevation. The body 10 includes an annular portion 11 circumferentially attaching to the handlebar stem 2, and the handlebar stem 2 is attached to the frame tube 3, and the annular portion 11 has one end abutted by the headset 4 while the other end abutted by the frame tube 3. The body 10 further includes a joining device 12 which includes two lugs 121 and 122 and one lug 121 includes a hole 123 while the other lug 122 includes an engagement hole 124 disposed thereon, respectively.

The collar 1 also includes a connecting device 20 which has a first end thereof including a joint 21 pivotally connected between the two lugs 121 and 122 of the body 10. The joint 21 includes a hole 211 extending therethrough, and the joint 21 is connected between the two lugs 121 and 122 by inserting a fastener 14 through the holes 123 and 211 successively and engaged in the engagement hole 124 thereafter. The engagement hole 124 has a depth, and the fastener 14 is engagable at various depths in the engagement hole 124. Further, a positioning device is utilized to securely retain the connecting device 20 at a predetermined pivoting position with respect to the body 10. The positioning device includes a detent 13 disposed on the body 10 and a plurality of positioning sections 212 disposed on the connecting device 20, and the detent 13 is selectively engagable with one of the plurality of positioning sections 212 in order to retain a predetermined pivoting position. In this embodiment, the detent 13 is a protrusion, the plurality of positioning sections 212 are ridges equally spaced from each other. So, the detent 13 is adapted to be releasably restricted between two of the plurality of positioning sections 212 for the predetermined pivoting position. However, it is understood other means of positioning device is within the scope of the present invention.

The connecting device 20 has a second end thereof including a quick-release mechanism 22 to which an accessory 5, 5′ is releasably attached. The accessory 5 is a light whereas the accessory 5′ is a light-reflecting member. However, it is understood that other types of accessories is within the scope of the invention.

The quick-release mechanism 22 includes at least two projecting arms 223, a slot 221 spacing the at least two projecting arms 223, a cavity 222 disposed on one of the at least two projecting arms 223, and an operating portion 224 extending from one of the at least two projecting arms 223. In this preferred embodiment, the at least two projecting arms 223 are parallel to one anther, and the number of the projecting arms 223 is three, and the cavity 222 is disposed on the middle projecting arm 223. Additionally, both accessories 5 and 5′ include an engaging portion 50 defining a space 51 releasably receiving the quick-release mechanism 22. The engaging portion 50 includes two walls 52 releasably engaged with two projecting arms 223, two guiding portions 53 releasably engaged in two slots 221, and a locking member 54 releasably engaged in the cavity 222. Further, to detach the accessories 5 or 5′ from the connecting device 20, the operating portion 224 is operably moved to disengage the locking member 54 from the cavity 222 so that the quick-release mechanism 22 is allowed to slide out of the engaging portion 50. It is noted that with slot 221, the operational movement of the operating portion 224 is facilitated. Also, the locking member 54 is in the form of a wedge to facilitate engagement in the cavity 222.

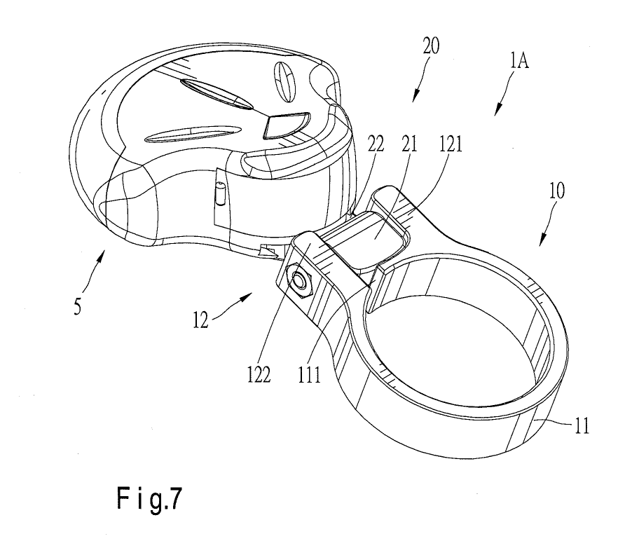

Referring to FIG. 7, a collar 1A embodying a second embodiment of the present invention is similar to the first embodiment except that the annular portion 11 is modified to become adjustable in size in order to accommodate various sizes of the handlebar stem 2. In this embodiment, the annular portion 11 includes an opening 111 variable in size. Also, the joint 21 of connecting device 20 is modified so as not to be pivotal with respect to the body 10. Further, the positioning device is eliminated.

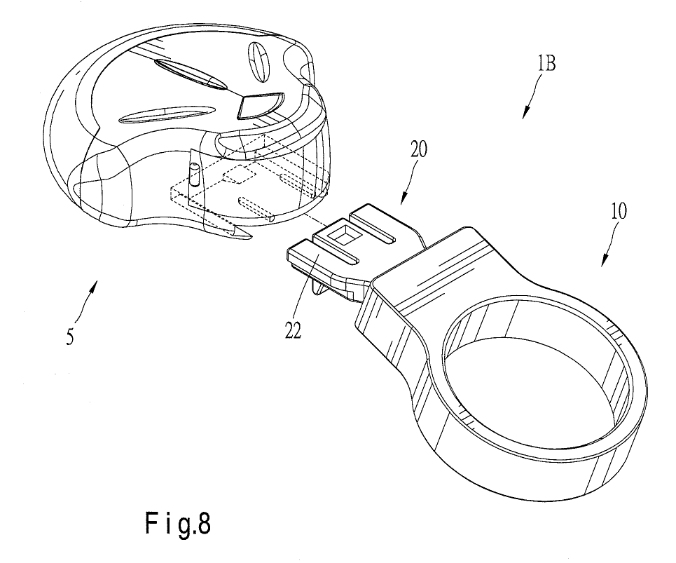

Referring to FIG. 8, a collar 1B embodying a third embodiment of the present invention is similar to the first embodiment except that the body 10 and the connecting device 20 are in one piece.

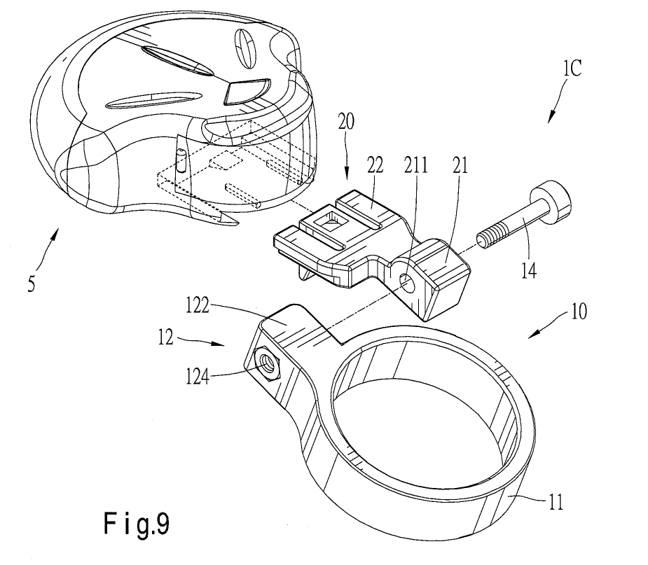

Referring to FIG. 9, a collar 1C embodying a fourth embodiment of the present invention is similar to the first embodiment except that the lug 121 and the positioning device are eliminated. Also, the joint 21 of connecting device 20 is modified so as not to be pivotal with respect to the body 10

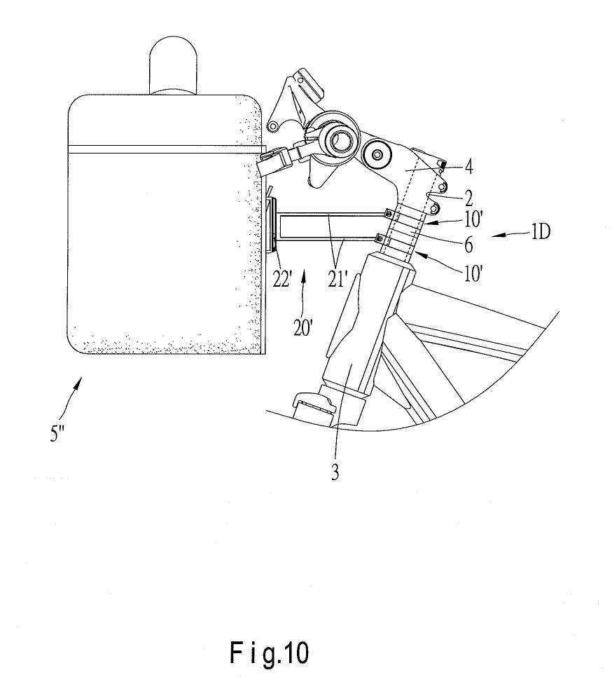

Referring to FIG. 10, a collar 1D embodying a fifth embodiment of the present invention includes two bodies 10 and each has a connecting device 20′ attached thereto. Each connecting device 20′ has a first end thereof having a joint 21′ connected to their respective body 10′ and a second end having a quick-release mechanism 22′ releasably connected to a bag 5″. Additionally, at least one ring 6 is disposed between the two bodies 10′, and the at least one ring 6 is also circumferentially attaching to the handlebar stem 2.

Based on the forgoing, it is therefore an aspect of the invention that the collar is adapted for bearing a headset 4 at a higher elevation with respect to the frame tube 3.

It is also an aspect of the invention that the collar has a connecting device 20 for attaching a bicycle accessory 5, 5′, 5″.

While the specific embodiments have been illustrated and described, numerous modifications come to mind without significantly departing from the spirit of invention and the scope of invention is only limited by the scope of accompanying claims.

What is claimed is:

1. A collar installed on a bicycle which includes a headset and a frame tube in which the headset is adjustably attached, with the headset including a handlebar stem, and with the handlebar stem attached to the frame tube, comprising:
a body including an annular portion circumferentially attaching to the handlebar stem for bearing the headset at a higher elevation with respect to the frame tube and safeguarding against a reversion of the headset to a lower elevation; and
a connecting device having a first end thereof having a joint connected to the body and a second end thereof having a quick-release mechanism to which an accessory is releasably attached.

2. The collar as claimed in claim 1 wherein the connecting device is pivotally connected to the body.

3. The collar as claimed in claim 2 further comprising a positioning device for securely retaining the connecting device at a predetermined pivoting position with respect to the body.

4. The collar as claimed in claim 3 wherein the positioning device includes a detent on one of the body and the connecting device, and a plurality of positioning sections on the other of the body and the connecting device, and wherein the detent is selectively engagable with one of the plurality of positioning sections.

5. The collar as claimed in claim 4 wherein the detent is a protrusion, and wherein the plurality of positioning sections are ridges, and the ridges are equally spaced, and wherein the detent is adapted to be releasably retained between two of the plurality of ridges for a predetermined pivoting position.

6. The collar as claimed in claim 1 wherein the annular portion has an internal diameter adjustable in size.

7. The collar as claimed in claim 6 wherein the annular portion includes an opening variable in size and depending upon a size of the handlebar stem attached.

8. The collar as claimed in claim 1 wherein the quick-release mechanism includes at least two projecting arms, a slot spacing the two projecting arms, a cavity disposed on one of the at least two projecting arms, and an operating portion extending from one of the at least two projecting arms, and wherein the accessory includes an engaging portion releasably receiving the quick-release mechanism, and the engaging portion includes a guiding portion releasably engaged in the slot, and a locking member releasably engaged in the cavity, and wherein the operating portion is operable to disengage the locking member from the cavity.

9. The collar as claimed in claim 8 wherein the locking member is in the form of a wedge.

10. The collar as claimed in claim 1 wherein the body includes a joining device including a lug and an engagement hole disposed on the lug, and wherein the joint includes a hole through the joint, and wherein the joint is connected to the lug by a fastener, with the fastener inserted through the hole and engaged in the engagement hole.

11. The collar as claimed in claim 10 wherein the engagement hole has a depth, and wherein the fastener is engagable at various depths in the engagement hole.
